(19) United States
(12) Patent Application Publication
(10) Pub. No.: US 2014/0074632 A1
(43) Pub. Date: Mar. 13, 2014

(54) TRANSACTION EXTENSION CHAINING

(71) Applicants: ATTA H. MATEEN, EDEN PRAIRIE, MN (US); JOHN STEELY, LA CRESCENTA, CA (US)

(72) Inventors: ATTA H. MATEEN, EDEN PRAIRIE, MN (US); JOHN STEELY, LA CRESCENTA, CA (US)

(21) Appl. No.: 13/726,181

(22) Filed: Dec. 23, 2012

Related U.S. Application Data
(60) Provisional application No. 61/698,479, filed on Sep. 7, 2012.

(51) Int. Cl. G06Q 20/10

(52) U.S. Cl. CPC G06Q 20/108
USPC 705/16; 705/43

(57) ABSTRACT

An embodiment of a transaction extension chaining method, includes using a cash access machine, receiving a request from a user to provide funds from a user account operated by an account provider via a first type of transaction, transmitting the request, receiving a denial of the request for funds because the request exceeded a transaction limit, and automatically obtaining the transaction limit of the user account from the account provider. The method further includes providing the transaction limit to be received by the user, and providing the user with an option to transmit an alternate request to provide funds from the user account via a second type of transaction.

### CROSS REFERENCE TO RELATED APPLICATION

This application claims the benefit of U.S. Provisional Application No. 61/698,479, filed on Sep. 7, 2012, which is hereby incorporated by reference in its entirety.

### BACKGROUND

1. Field of the Invention

The present invention relates to cash access methods and systems, and in particular to transaction extension chaining.

2. Description of the Related Art

Conventional systems for accessing cash include using a debit or credit card at an ATM. Conventional systems, however, may cause a user to inadvertently access more cash than they currently have available in their accounts, thus triggering potentially expensive overdraft penalties and/or fees. In addition, using such conventional systems may be time consuming and/or difficult to use. Accordingly, improvements may be made in the system.

### SUMMARY

In an aspect, a transaction extension chaining method includes using a cash access machine, receiving a request from a user to provide funds from a user account operated by an account provider via a first type of transaction. The method further includes transmitting the request, and receiving a denial of the request for funds because the request exceeded a transaction limit. The method further includes automatically obtaining the transaction limit of the user account from the account provider, and providing the transaction limit to be received by the user. The method further includes providing the user with an option to transmit an alternate request to provide funds from the user account via a second type of transaction.

The transaction limit may be acquired after the denial of the request. The transaction limit may be an account limit, a daily withdrawal limit, an account balance, a point-of-sale limit, and a credit limit.

The first type of transaction may be a cash withdrawal from a user account, and the second type of transaction may be a cash advance from the user account, a point-of-sale transaction from the user account, or a combination of at least two of a cash withdrawal, a cash advance, and a point-of-sale transaction from the user account.

The system may provide the account balance to the user using one of a screen of the cash access machine, an email, a text message, and a printed receipt.

In some embodiments, the method further includes displaying the fees associated with each transaction option based on a proposed cash disbursal amount. The proposed cash disbursal amount may be one of the requested amount, the account balance, a daily transmission limit, and a combination of transaction amounts that add up to the requested amount.

In another aspect, a cash access machine is configured to perform transaction extension chaining, the cash access machine being configured to receive a request from a user to provide funds from a user account operated by an account provider via a first type of transaction, transmit the request, and receive a denial of the request for funds because the request exceeded a transaction limit. The cash access machine is further configured to automatically obtain the transaction limit of the user account from the account provider, provide the transaction limit to be received by the user, and provide the user with an option to transmit an alternate request to provide funds from the user account via a second type of transaction.

In another aspect a computer-readable medium includes instructions that, when executed by a processing unit, cause the processing unit to perform the operations of, using a cash access machine, receiving a request from a user to provide funds from a user account operated by an account provider via a first type of transaction. The computer-readable medium further includes instructions that, when executed by a processing unit, cause the processing unit to perform the operations of transmitting the request, receiving a denial of the request for funds because the request exceeded a transaction limit, automatically obtaining the transaction limit of the user account from the account provider, providing the transaction limit to be received by the user, and providing the user with an option to transmit an alternate request to provide funds from the user account via a second type of transaction.

### BRIEF DESCRIPTION OF THE DRAWINGS

FIG. 1 is a schematic diagram of components that may operate with the system, according to an embodiment;

FIG. 2 is an exemplary computer system that may be configured to perform any of the processes described herein;

FIG. 3 is an illustration of a process flow of transaction extension chaining, according to an embodiment;

FIG. 4 is an illustration of another process flow of transaction extension chaining, according to an embodiment;

FIG. 5 is an illustration of an additional process flow of transaction extension chaining, according to an embodiment;

FIG. 6 is an illustration of a flow diagram for obtaining cash from a user account via an ATM;

FIG. 7 is an illustration of an additional process flow of transaction extension chaining, according to an embodiment;

FIG. 8 is an illustration of an additional process flow of transaction extension chaining, according to an embodiment; and

FIGS. 9 through 12 are illustrations of user interfaces for transaction extension chaining, according to an embodiment.

### DESCRIPTION OF EXEMPLARY EMBODIMENTS

At an automated teller machine (ATM), a user can insert an ATM or debit card into the machine, enter a Personal Identification Number (PIN), and select an amount of cash. The cash is then disbursed by the machine, provided there is enough cash within the person's account and the amount is within a preset limit. For example, the preset limit may be established by a bank, and can be $300 a day. If additional cash is needed, the user may be prevented from accessing additional cash from their account until the next day.

An alternate method of accessing funds in an account may be through the purchase of an item or service. When such a purchase is made via an EFT with a debit or ATM card, the money is debited from the person's account as a point-of-sale (POS) transaction. The limit for POS transactions may be based on the available balance of account holder and/or may be a higher limit than the ATM daily withdrawal limit. Accordingly, an account holder can reach their ATM limit and be prevented from obtaining more cash that day from an ATM, but the account holder may still be able to purchase goods and services via a point-of-sale transaction because of the separate limit for point-of-sale transactions.

With a credit card, an account holder can make a point-of-sale transaction for the purchase of goods and services, or can obtain a cash advance using a PIN number. If the PIN has been forgotten, the account holder may be prevented from obtaining the cash advance.

In an embodiment, a method and system for providing funds to an account holder includes identifying the account to a terminal, entering a personal identification number into the terminal, requesting money from the account via cash withdrawal transaction, and forwarding the request to a processor. The request is forwarded from the processor to an issuer designated network, and the consumer request is forwarded from the issuer designated network to a bank. The bank may make a denial of the cash withdrawal, and forward the denial to the processor. An option may be provided to the customer by displaying their account balance on an ATM screen or on a receipt. The account holder may then make an intelligent decision to proceed further either by requesting a lesser amount of cash withdrawal or by selecting an amount to be disbursed that is less than the account balance. The account holder may thus plan appropriately to avoid any overdraft charges that a financial institution may impose on the customer's account.

The POS transaction may then be forwarded to the processor. The POS transaction may then be forwarded from the processor to an issuer designated network. The request may then be forwarded from the issuer designated network to the bank, which may approve the POS transaction. The approval may be forwarded to the processor, and the ATM may disburse cash or provide instructions (such as on a receipt, script, or ticket) for a cash disbursal location to provide funds to the account-holder. For example, money may be disbursed to the account holder at a secured cage location by presenting government issued identification.

In accordance with yet another aspect of the present invention, the method further includes by providing the service of account balance to the account-holder an option to select a lower amount of withdrawal or select other type of transaction i.e. POS and select an amount lower than the available balance.

In accordance with another aspect, the entered amount is compared with the account balance of the customer, and only allows disbursal of a restricted amount that can be paid along with any surcharge without exceeding the account balance.

In accordance with a further aspect, the ATM network and point-of-sale networks are integral.

In accordance with another aspect of the present invention, a backend server compares the card number and account holder's information with a “blocked customer” table. Additional identification information may be requested from the account holder, such as visual confirmation of the account holder's appearance via camera or an ATM attendant, through additional card swipes of other cards that also belong to the account holder. In addition, a supervisor may review the transaction prior to approval of the transaction and disbursement of funds to the account holder. These additional checks may provide additional fraud protection to mitigate the risk of fraudulent transactions occurring at an ATM.

In accordance with another aspect, the method includes paying, on behalf of a person, for an item of value from an account of the person held by a custodian of the account. The method further includes identifying the account to a terminal, requesting the item from the account via a first type of transaction, forwarding the first type of transaction to a processor, forwarding the first type of transaction from the processor to an issuer designated network, forwarding the first type of transaction from the issuer designated network to the custodian of the account, and having the first type of transaction be denied.

The method may further include the denial being forwarded to the processor, requesting the item from the account via a second type of transaction, forwarding the second type of transaction to the processor, having the second type of transaction be forwarded from the processor to a second network, having the second type of transaction be forwarded from the second network to the custodian of the account, having the second type of transaction be approved, and having the approval be forwarded to the processor. The method may further include instructing the person to contact a dispenser, and instructing the dispenser to provide the person with the item of value.

In accordance with another aspect of the present invention, a method of paying, on behalf of a person, for an item of value from a credit card account without using a personal identification number. The method may include inserting a credit card into a terminal, making a request for the item, forwarding the request to a processor, forwarding the request from the processor to a point-of-sale network, forwarding the request from the point-of-sale network to an institution that issued the credit card, making an approval of the request, forwarding the approval to the processor, and instructing a dispenser to provide the item to the account-holder.

Accordingly, a terminal and a method in accordance with the present invention enable an account holder to obtain money from a bank account via either an ATM network or a point-of-sale network. Additionally, money can be obtained with a credit card or debit card without utilizing a PIN. If the account holder has forgotten their PIN, they will still be able to obtain a cash advance with a credit card. Additionally, if one reaches their ATM limit, more cash may be obtained via the point-of-sale network.

Other features and advantages will be understood upon reading and understanding the detailed description of exemplary embodiments, described below, in conjunction with reference to the drawings, in which like numerals represent like elements.

### Exemplary System

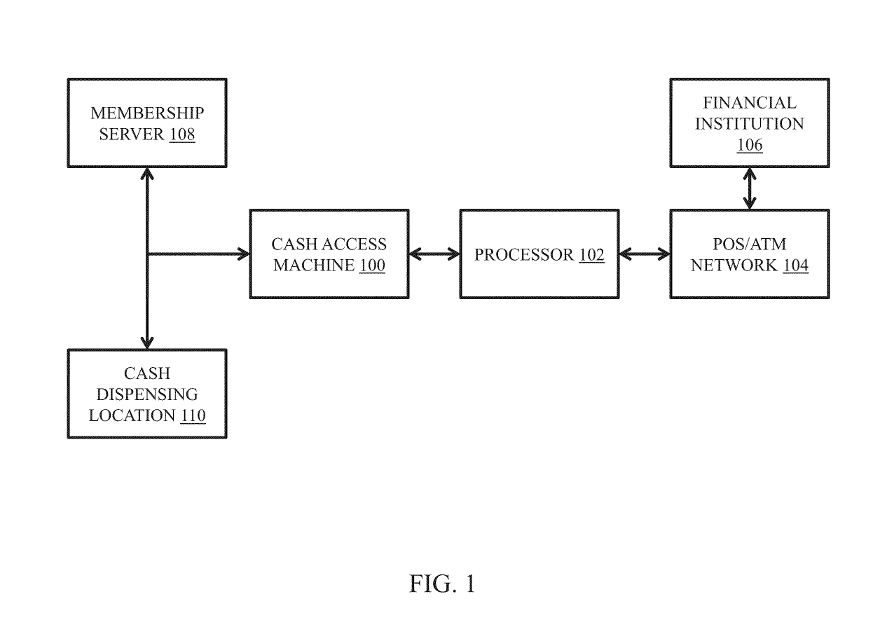

FIG. 1 is a schematic diagram of components that may operate with the system, according to an embodiment. FIG. 1 includes a cash access machine 100, a processor 102, a Point Of Sale/Automated Teller Machine (POS/ATM) Network 104, a financial institution 106, a membership server 108, and a cash dispensing location 110. The cash access machine 100 may include an ATM, a personal computer, a network computer, a client, or a tablet computer. The financial institution 106 may be a bank, a credit union, a brokerage firm, an investment bank, a trust company, a casino membership account, etc. The cash dispensing location 110 may be a casino cage, a cash recycler operated by a cashier, a terminal, or a cash dispensing machine.

The cash access machine 100 may communicate with the membership server 108, the processor 102, or directly with the financial institution 106 to verify that a user of the cash access machine 100 (e.g., an account owner) is authorized to receive funds and/or is not on a fraud list. The communication may be accomplished using a direct connection, a local area network, a wide area network, and/or the internet. The processor 102 may communicate with the financial institution 106 via a POS/ATM Network 104, which may include either or both of a POS network and an ATM network. In some embodiments, the POS network and the ATM network are integral. Once authorization has been confirmed, the cash access machine may dispense cash or enable the user/account owner to obtain funds from the cash dispensing location 110.

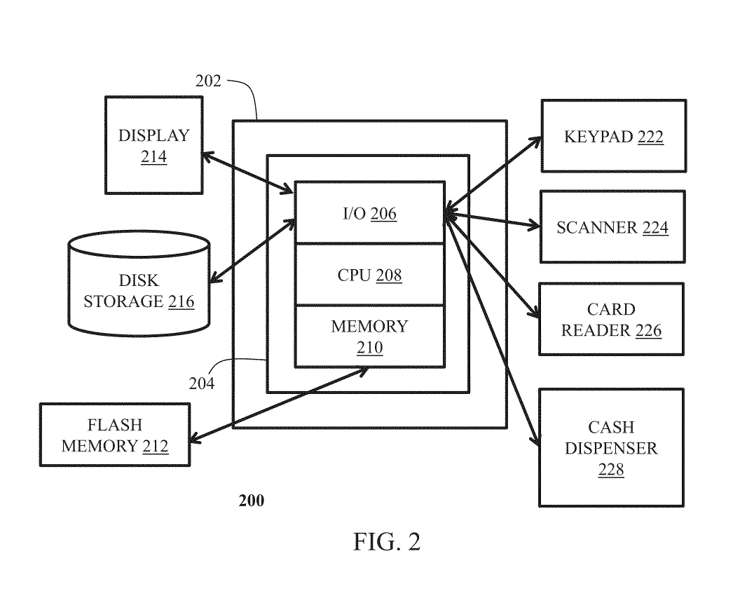

FIG. 2 is an exemplary computing system 200 that may be configured to perform any of the processes described herein, and may represent the cash access machine 100. In this context, computing system 200 may include, for example, a processing unit (e.g., a CPU 208), memory 210, disk storage 216, I/O 206, and I/O devices (e.g., display 214, keypad 222, disk drive, flash memory 212, Internet connection, PIN pad, printer 218, etc.). Computing system 200 may also include specialized circuitry or other hardware for carrying out some or all aspects of the processes. In some embodiments, computing system 200 may be configured as a system that includes one or more units (e.g., multiple core processors, network computers, computers operating in parallel, etc.), each of which is configured to carry out some aspects of the processes either in software, hardware, or some combination thereof.

As shown in FIG. 2, computing system 200 includes main system 202, which includes a motherboard 204 having an I/O section 206, one or more central processing units (CPU) 208, and a memory section 210. The memory may be connected to flash memory 212.

The I/O section 206 can be connected to a display 214, a printer 218, a keyboard 222 and/or other user input devices (e.g., a scanner 224, a card reader 226, a cash dispenser 228), and a disk storage unit 216. The scanner 224 may include a bar code scanner, a QR code scanner, an image scanner, an RFID tag reader, a Near Field Communication (NFC) reader, or other input systems. The card reader 226 may include a magnetic stripe reader.

The disk storage unit 216, the memory 210, and/or the flash memory 212 may include a computer-readable medium that can contain programs and/or data. Computing system 200 can include a web browser. Moreover, it is noted that computing system 200 can be configured to include additional systems in order to fulfill various functionalities.

At least some values based on the results of the processes described herein can be saved for subsequent use. Additionally, a computer-readable medium can be used to store (e.g., tangibly embody) one or more computer programs for performing any one of the processes described herein by means of a computer. The computer program may be written, for example, in a general-purpose programming language (e.g., Pascal, C, C++, Java, Python) or some specialized application-specific language (PHP, Java Script).

### Exemplary Process Flows of Transaction Extension Chaining

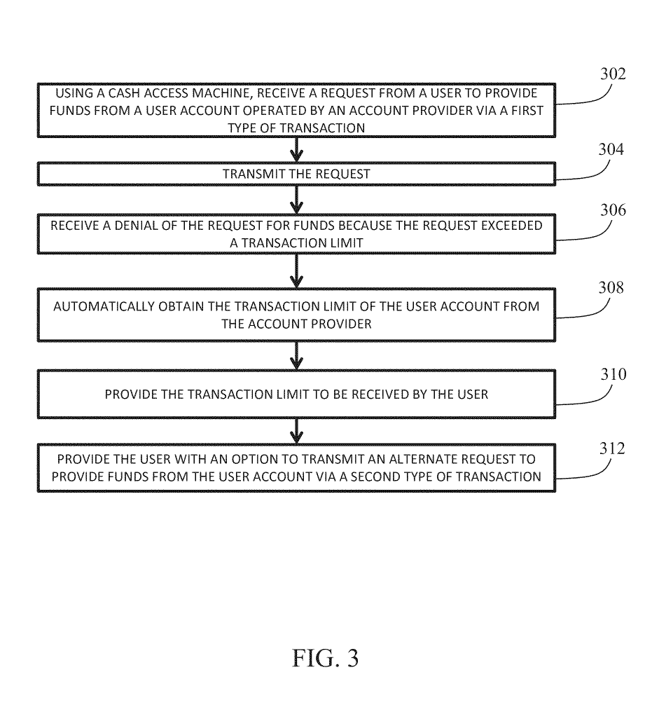

FIG. 3 is an illustration of a process flow of transaction extension chaining, according to an embodiment. In operation 302, using a cash access machine 100, the system receives a request from a user (e.g., an account holder) to provide funds from a user account operated by an account provider via a first type of transaction. For example, the user may swipe a debit or credit card and select a cash withdrawal, a cash advance, or another type of transaction from a user interface menu of the cash access machine 100. The account provider may be the financial institution 106.

The computer system 200 may represent the cash access machine 100, and the user interface may be presented to the user via the display 214 (e.g., a touchscreen display). The user may make selections via the display 214 and/or the keypad 222.

In operation 304, the system transmits the request, such as to the processor 102 and/or the financial institution 106. For example, the CPU 208 may transmit the request via the I/O 206 to be forwarded via a network (e.g., a local area network, the internet, etc.) to the processor 102.

In operation 306, the system receives a denial of the request for funds because the request exceeded a transaction limit. The transaction limit may be a daily withdrawal limit for a bank account, an account balance limit, a credit limit for a credit card, a daily point-of-sale limit for a debit card, or a fraud alert limit. The denial may be provided by the financial institution 106.

In operation 308, the system automatically obtains the transaction limit of the user account from the account provider.

In operation 310, the system provides the transaction limit to be received by the user. For example, the system may provide the transaction limit to the user via the display 214, a receipt/ticket/slip printed using the printer 218, an email, a text message, or an audible message, such as via a phone call.

In operation 312, the system provides the user with an option to transmit an alternate request to provide funds from the user account via a second type of transaction. The second transaction type may be distinct from the first type of transaction. For example the first request may be a withdrawal request from a checking or savings account, and the second request may be a debit advance from the same account. Alternatively, the second request may be a credit advance or POS transaction.

In some embodiments, the user may be provided with an option to send another request for funds using the same type of transaction but in an amount that would fall below the transaction limit.

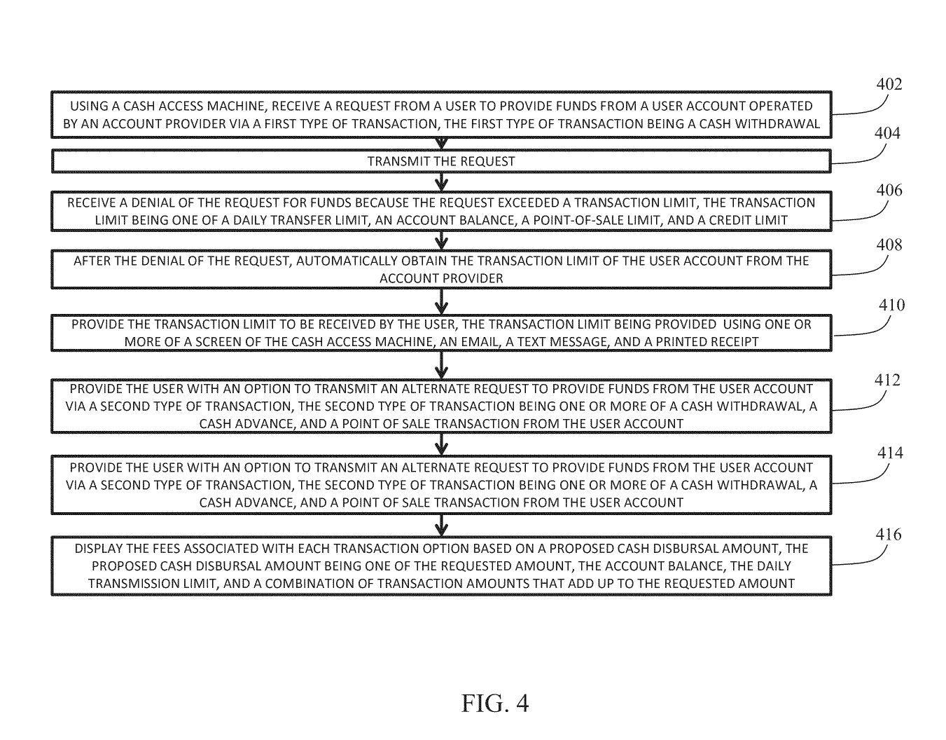

FIG. 4 is an illustration of another process flow of transaction extension chaining, according to an embodiment. In operation 402, using a cash access machine, the system receives a request from a user to provide funds from a user account operated by an account provider via a first type of transaction, the first type of transaction being a cash withdrawal.

In operation 404, the system transmits the request. In operation 406, the system receives a denial of the request for funds because the request exceeded a transaction limit, the transaction limit being one of a daily transfer limit, an account balance, a point-of-sale limit, and a credit limit.

In operation 408, after the denial of the request, the system automatically obtains the transaction limit of the user account from the account provider. In operation 410, the system provides the transaction limit to be received by the user, the transaction limit being provided using one or more of a screen of the cash access machine, an email, a text message, and a printed receipt.

In operation 412, the system provides the user with an option to transmit an alternate request to provide funds from the user account via a second type of transaction, the second type of transaction being one or more of a cash withdrawal, a cash advance, and a point of sale transaction from the user account

In operation 414, the system provides the user with an option to transmit an alternate request to provide funds from the user account via a second type of transaction, the second type of transaction being one or more of a cash withdrawal, a cash advance, and a point of sale transaction from the user account

In operation 416, the system displays the fees associated with each transaction option based on a proposed cash disbursal amount, the proposed cash disbursal amount being one of the requested amount, the account balance, the daily transmission limit, and a combination of transaction amounts that add up to the requested amount. For example, the system may propose that the user withdraw the maximum amount possible from an available balance in the user's account while leaving sufficient funds to pay for any transaction fees. Alternatively, the system may propose that the user withdraw as much as possible via a cash withdrawal, with the remainder of the original denied request for funds being provided via a second type of transaction, such as a debit advance, or a credit POS transaction.

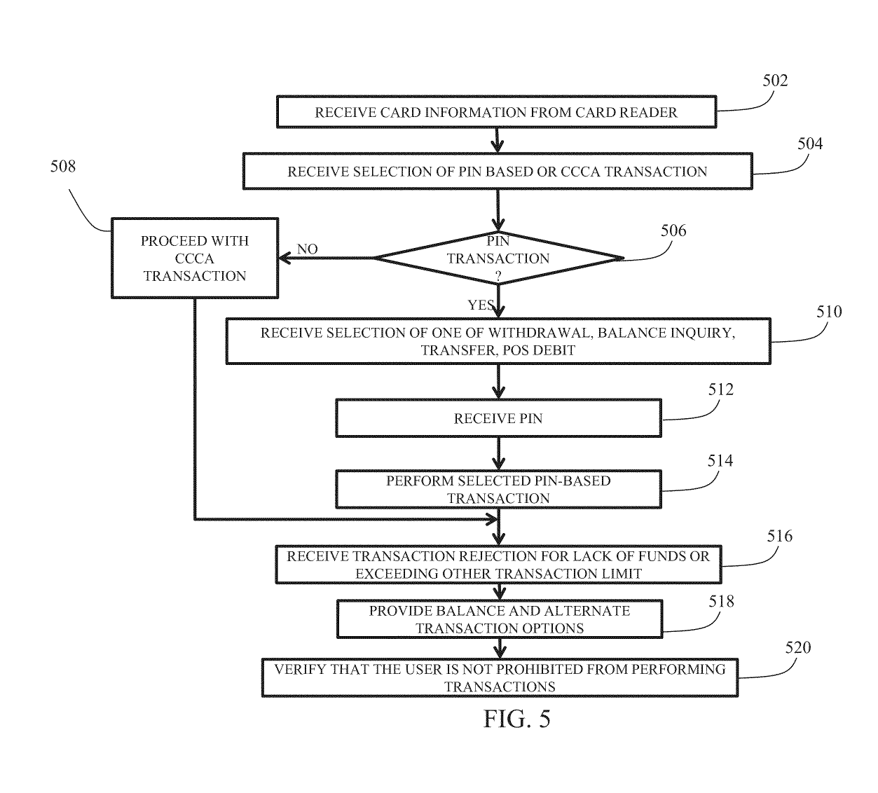

FIG. 5 is an illustration of an additional process flow of transaction extension chaining, according to an embodiment. In operation 502, the system receives card information from the card reader 226. The information may be personal information from a government issued ID, such as name, birth date, driver's license, address, phone number, image, or other information. Alternatively, the card information may be credit card or debit card information, such as an account number, a routing number, an expiration date, a billing zip code, and a security code.

The user may then be prompted to choose between a PIN based and a Credit Card Cash Advance (CCCA) transaction. In operation 504, the system receives the user's selection of a PIN based or a CCCA transaction. In operation 506, the system determines whether either a PIN transaction or a CCCA was selected. If a PIN transaction was selected, the system proceeds to operation 510. Otherwise, the system proceeds with the CCCA transaction in operation 508, and then proceeds to operation 516.

If a PIN-based transaction was selected, in operation 510, the system receives the user's selection of a transaction that is one of a withdrawal, a balance inquiry, a transfer, and a POS debit. In operation 512, the system receives a PIN from the user. In operation 514, the system performs the selected PIN-based transaction.

In operation 516, the system receives a transaction rejection for lack of funds or exceeding another transaction limit. In operation 518, the system provides the user's account balance and alternate transaction options for disbursing cash to the user. In operation 520, the system verifies that the user is not prohibited from performing transactions, such as by comparing the user's name, card number, and/or other identifying information is not on a blocked list.

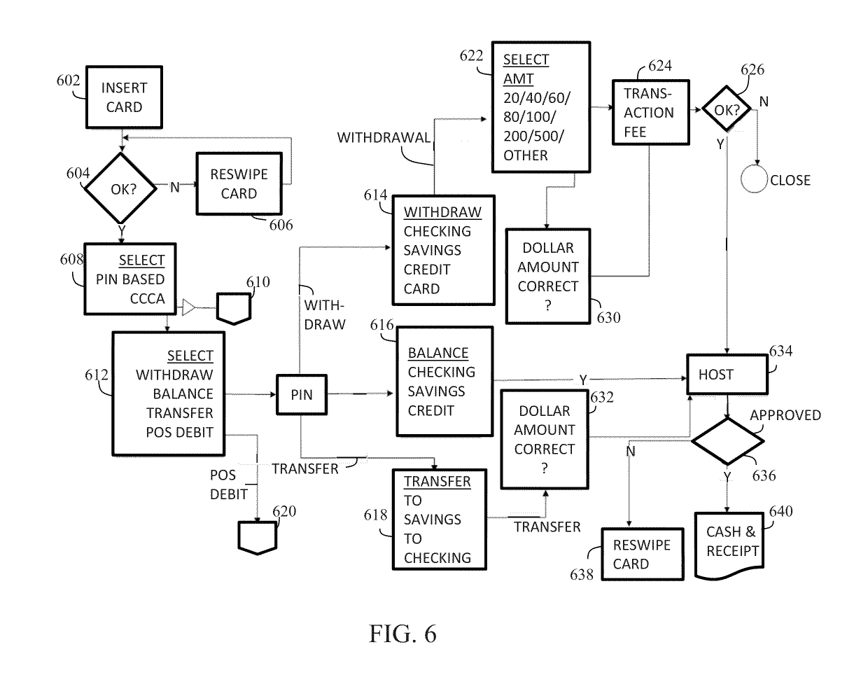

FIG. 6 is an illustration of a flow diagram for obtaining cash from an account via an ATM. In operation 602, the user is presented with a welcome screen and invited to insert a card to begin a transaction. In operation 604, if the card was not swiped correctly, in operation 606, the user is asked to re-swipe their card. Otherwise, in operation 608, the user is provided with an option to select either a PIN based transaction or a CCCA transaction. If the CCCA transaction is selected, the system provides the user with the requested transaction in operation 610.

If the user selects a PIN based transaction, in operation 612, the user is presented with the option of performing a withdrawal, a balance inquiry, a transfer, or a POS debit transaction. The user may then be prompted to enter their PIN. If the user selects a POS debit, the operation proceeds with operation 620.

If a withdrawal is selected in operation 612, then in operation 614, the user is asked to select an account from which to withdraw funds. For example, the user may choose a checking, savings, or credit account.

In operation 622, the user is presented with options for selecting varying amounts cash to be disbursed. If the user wishes to pick a specific dollar amount to be disbursed, in operation 628, the user is asked to enter a dollar amount and then to confirm that the dollar amount is correct. In operation 624, once an amount has been selected in either operation 622 or 628, the user is presented with a screen asking the user to confirm that they are willing to pay a transaction fee. In operation 626, if the user does not wish to pay the transaction fee, the transaction is closed. If the user does wish to pay the transaction fee the request is forwarded to the host in operation 630.

If the user selects a balance inquiry in operation 612, then in operation 616, the inquiry is forwarded to the host in operation 630.

If the user selects a transfer in operation 612, then in operation 618, the user can determine which accounts to make a transfer between. In operation 638, the user can determine the dollar amount to transfer. The system then forwards the transfer instruction to the host in operation 630.

In operation 632, if the transaction is approved, then if appropriate, cash is disbursed and/or a receipt/ticket/script is provided to the user in operation 634. If the transaction is not approved, then in operation 636, the user's card is re-swiped for a debit/credit transaction.

### Insufficient Funds

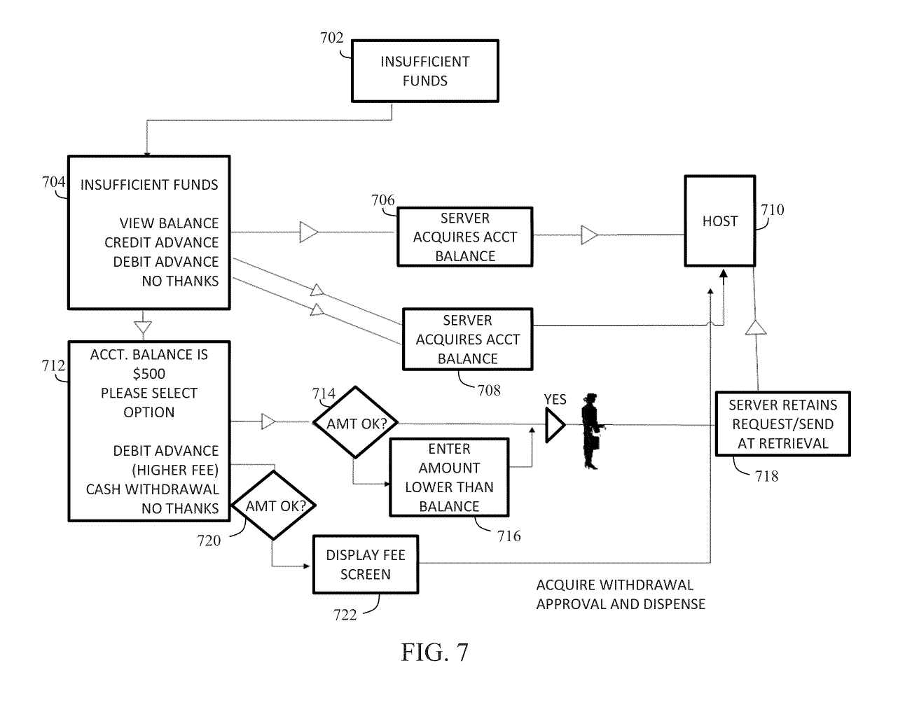

FIG. 7 is an illustration of an additional process flow of transaction extension chaining, according to an embodiment. In operation 702, if a transaction is denied for insufficient funds, the user may be provided with the options as shown in operation 704 and the notice that there were insufficient funds. As shown in operation 704, the user may have the option of viewing their balance, obtaining a credit or debit advance, or declining to proceed with the transaction.

In operation 706 and 708, the server acquires the account balance and relays the request to the host 710.

In operation 712, the user is provided with an account balance and options for an alternate type of transaction such as a debit advance for which a higher fee might apply, a cash withdrawal, or a refusal to proceed with the transaction. In operation 714, if a debit advance is requested, the system may check to make sure the amount requested is now lower than the account balance. If the amount is greater, than in operation 716, the system requests that the user provide an amount lower than the account balance. In operation 718, the server retains the request or sends the request at interval to the host 710.

In operation 720, if a cash withdrawal is selected and the amount is less than the account balance, then in operation 722, the system provides a display fee screen. If the fee is accepted, then the system requests approval for the withdrawal from the host 710.

### Daily Limit Exceeded

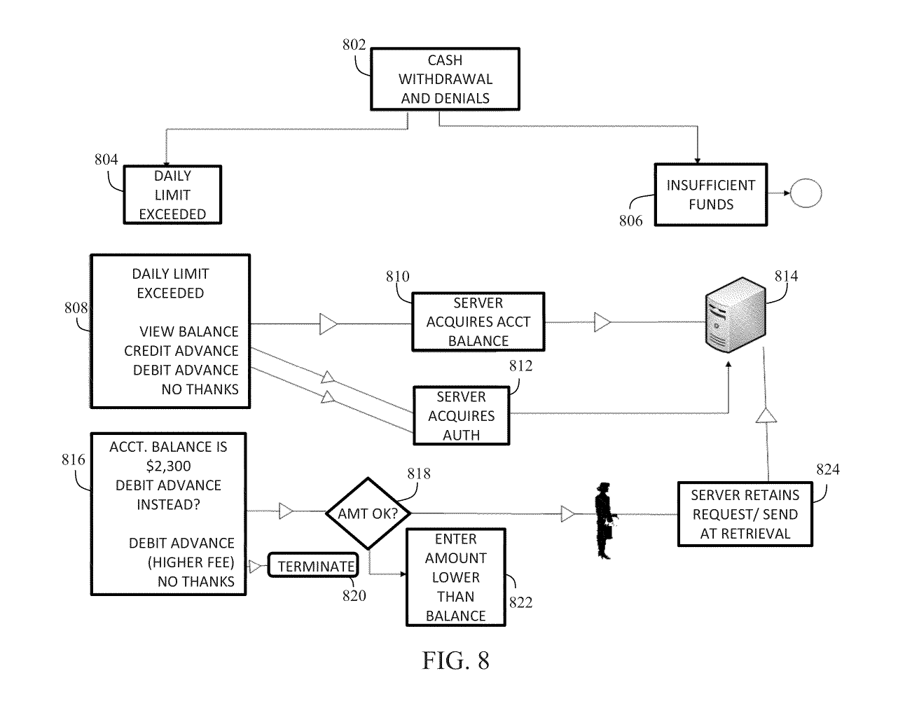

FIG. 8 is an illustration of an additional process flow of transaction extension chaining, according to an embodiment. Operation 802, indicates that cash withdrawal denials may occur when a daily limit is exceeded, such as in operation 804, or when there are insufficient funds, such as in operation 806. Procedures for insufficient funds may be similar to the operations of FIG. 7.

In operation 808, the user may be notified that a daily limit has been exceeded, and the user may be given options to view their balance, obtain a credit advance, or obtain a debit advance. In operation 810, the server 814 acquires the account balance. In operation 812, the server 814 acquires authorization for a credit or debit advance.

In operation 816, the user is given the account balance, and options to perform a debit advance or to decline the transaction. In operation 818, if the amount requested is less than the account balance, then in operation 824, the server retains the request and sends it at retrieval.

In operation 820, if the user asks to cancel the transaction, all operations are terminated.

In operation 822, if the amount requested exceeds the account balance, then the system asks the user to enter an amount less than the balance.

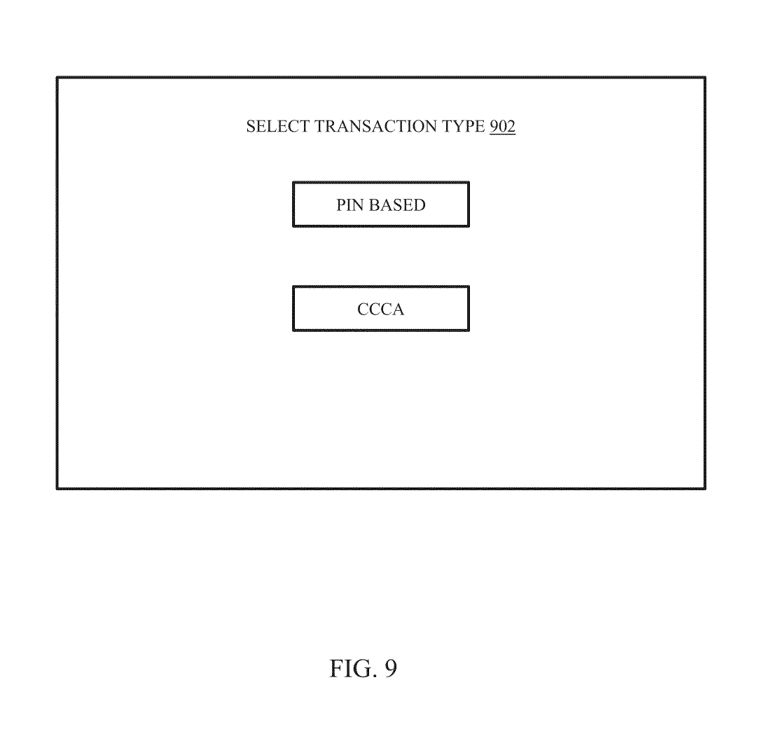

FIGS. 9 through 12 are illustrations of user interfaces for transaction extension chaining, according to an embodiment.

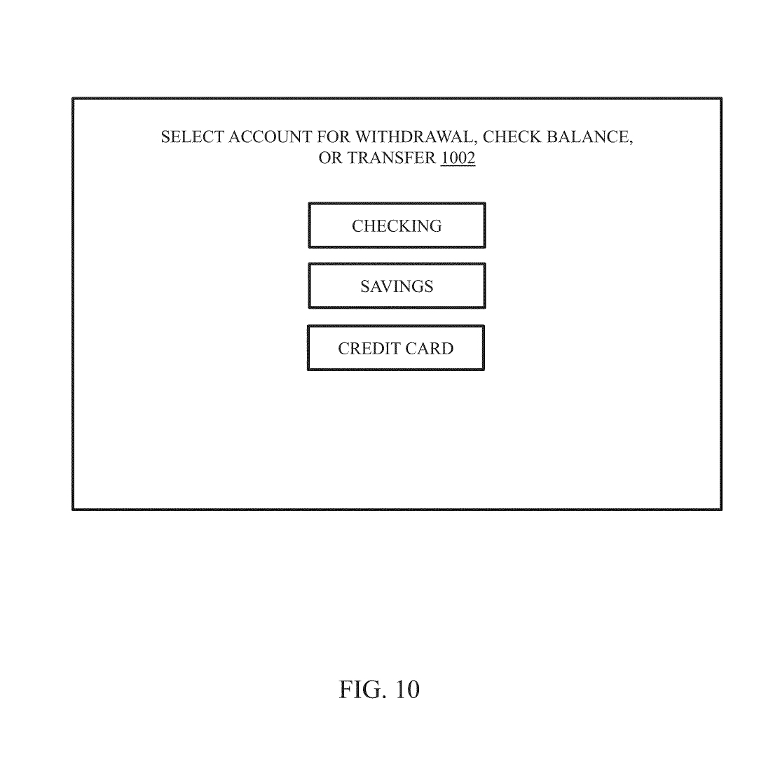

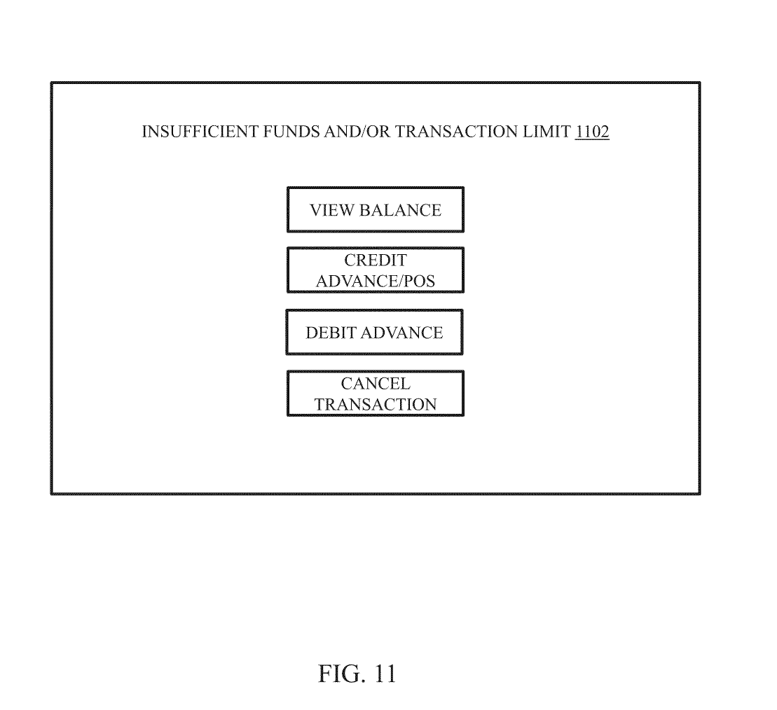

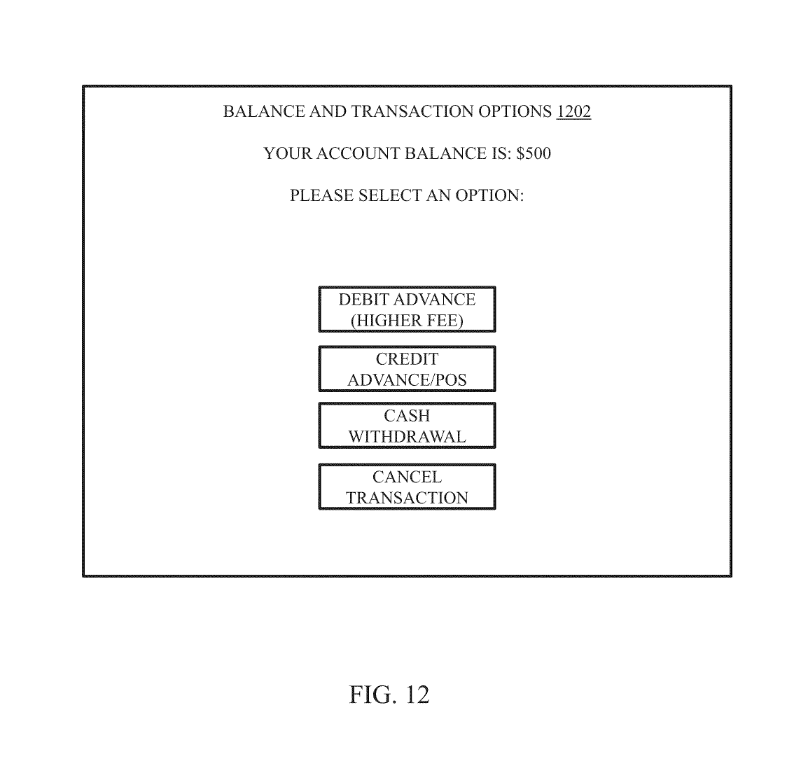

FIG. 9 illustrates a screen for selecting a transaction type 902 between PIN based and CCCA. FIG. 10 illustrates a screen for selecting an account for a withdrawal, checking balance, or transfer 1002. Accounts that may be manipulated include checking, savings and one or more credit cards. FIG. 11 illustrates a screen for informing the user that there are insufficient funds and/or a transaction limit has been exceeded 1102. Options that may be provided to the user include: viewing the user's account balance, obtaining a credit advance and/or a POS sale, a debit advance, and cancelling the transaction. In FIG. 12, the user is provided with balance and transaction options 1202.

### Additional Embodiments

In an embodiment, a method of providing money or an item of value to an account-holder includes identifying an account to a terminal, entering a personal identification number into the terminal, requesting money based upon the account via a withdrawal transaction, and forwarding the withdrawal transaction to backend processor. The method further includes forwarding the withdrawal transaction from the processor to an issuer designated network, forwarding the withdrawal transaction from the issuer designated network to a bank, making a denial of the withdrawal transaction due to exceeded pre-set limit, and forwarding the denial to the processor. The denial could be for insufficient funds or for exceeding a daily limit.

### Insufficient Funds

In another embodiment, the method includes notifying the account-holder at the terminal of the denial of the withdrawal transaction, and asking the account-holder if they would like to review account balance and entering a lower-amount for the withdrawal transaction.

The method may further include notifying the account-holder at the terminal of the denial of the withdrawal transaction, and asking the account-holder if they would like to review the account balance before requesting the money via a debit transaction, requesting money from the account via debit transaction, verifying that the selected amount is less than the account balance, and verifying that the requestor's name and account do not appear on a blocked customer list.

The method may further include forwarding the request of transaction to the processor, forwarding the POS transaction from the processor to a second network, forwarding the POS transaction from the second network to the bank, making an approval of the second type of transaction, forwarding the approval to the processor, and instructing a money location separate from the terminal to provide money or an item of value to the account-holder. The method may further include providing an option to the customer to perform a credit card PIN-less transaction instead and retrieve the cash at the cashier cage.

### Daily Limit Exceeded

In an embodiment, the method may include notifying the account-holder at the terminal of the denial of the first type of transaction, and asking the account-holder if they would like to review the account balance before requesting the money via a POS transaction, verifying that the patron name and account do not appear on “blocked customers” list, and if not, requesting money or an item of value based upon the account via POS transaction. The method may further include forwarding the POS transaction to the processor, forwarding the POS transaction from the processor to a second network, forwarding the POS transaction from the second network to the bank, making an approval of the second type of transaction, forwarding the approval to the processor, and instructing a money location separate from the terminal to provide money or an item of value to the account-holder.

The method may further include instructing the account-holder at the terminal to go to the money location. The method may also include providing a check to the money location, imprinting one of an ATM card, a POS card or a credit card on the check, and providing a copy of the check to the account-holder at the money location. The method may also include providing cash at the money location to the account-holder. The issuer designated network may be an ATM network and the second network may be a point-of-sale network. The ATM network and the POS network may be integral. The terminal may issue a script to the account-holder and the account-holder may present the script to the money location. The money location may request information from the processor about the transaction to determine whether to provide money or an item of value to the account-holder.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

1. A transaction extension chaining method, comprising:
using a cash access machine, receiving a request from a user to provide funds from a user bank account operated by an account provider via a first type of transaction, the first type of transaction being a cash withdrawal;
transmitting the request;
receiving a denial of the request for funds because the request exceeded a transaction limit of the user bank account;
automatically obtaining the account balance of the user bank account from the account provider;
automatically providing the account balance to be received by the user;
using a display of the cash access machine, providing the user with an option to transmit an alternate request to provide funds via a second type of transaction.

2. The method of claim 1, wherein, after the denial of the request, the transaction limit is automatically provided to be received by the user.

3. The method of claim 1, wherein the transaction limit is a daily withdrawal limit.

4. The method of claim 1, wherein the second type of transaction is a cash advance from the user account.

5. The method of claim 1, wherein the second type of transaction is a point-of-sale transaction from the user account.

6. The method of claim 1, wherein the second type of transaction is a combination of a cash advance and a point-of-sale transaction from the user bank account.

7. The method of claim 1, wherein the account balance is provided to the user using the display of the cash access machine.

8. The method of claim 1, wherein the transaction limit is one of an account balance, a point-of-sale limit, and a credit limit.

9. The method of claim 6, further comprising
using the display of the cash access machine, displaying the fees associated with each transaction option of the combination.

10. (canceled)

11. A cash access machine configured to perform transaction extension chaining, the cash access machine being configured to:
receive a request from a user to provide funds from a user bank account operated by an account provider via a first type of transaction, the first type of transaction being a cash withdrawal;
transmit the request;
receive a denial of the request for funds because the request exceeded a transaction limit of the user bank account;
automatically obtain the account balance of the user account from the account provider;
automatically provide the account balance to be received by the user;
using a display of the cash access machine, provide the user with an option to transmit an alternate request to provide funds via a second type of transaction.

12. The cash access machine of claim 11, wherein, after the denial of the request, the transaction limit is automatically provided to be received by the user.

13. The cash access machine of claim 11, wherein the transaction limit is a daily withdrawal limit.

14. The cash access machine of claim 11, wherein the second type of transaction is a combination a cash advance and a point-of-sale transaction from the user account.

15. The cash access machine of claim 11, wherein the transaction limit is one of an account balance, a point-of-sale limit, and a credit limit.

16. (canceled)

17. A non-transitory computer-readable medium including instructions that, when executed by a processing unit, cause the processing unit to perform the operations of:
using a cash access machine, receiving a first request from a user to provide funds from a user bank account operated by an account provider, the first request being a cash withdrawal;
transmitting the request;
receiving a denial of the request for funds because the request exceeded a transaction limit of the user bank account;
automatically obtaining the account balance of the user account from the account provider;
automatically providing the account balance to be received by the user;
using a display of the cash access machine, providing the user with an option to transmit a second request to provide funds.

18. The computer-readable medium of claim 17, wherein the transaction limit is a daily withdrawal limit.

19. The computer-readable medium of claim 17, wherein the second request is a combination of a cash advance and a point-of-sale transaction from the user account.

20. The computer-readable medium of claim 17, wherein the transaction limit is one of an account balance, a point-of-sale limit, and a credit limit.

21. The method of claim 1, wherein the account balance is provided to the user using at least one of email and a text message.

22. The method of claim 1, wherein, in response to the denial of the request for funds, the account balance is provided to be received by the user.
